(19) United States
(12) Patent Application Publication
(10) Pub. No.: US 2022/0009350 A1
(43) Pub. Date: Jan. 13, 2022

(54) SYSTEM AND METHOD FOR GENERATING CONTENT RECOMMENDATION RULES FOR A VEHICLE

(71) Applicant: Xevo Inc., Bellevue, WA (US)

(72) Inventors: Christopher Philip Jordan, Bellevue, WA (US); Michael Peace Jonas, Bellevue, WA (US)

(21) Appl. No.: 16/925,146

(22) Filed: Jul. 9, 2020

(51) Int. Cl. B60K 35/00; G06F 16/9535

(52) U.S. Cl. CPC B60K 35/00; B60K 2370/1868; B60K 2370/164; G06F 16/9535

(57) ABSTRACT

Embodiments are directed towards a system and method of generating content recommendation rules for a vehicle head unit. A content recommendation and telemetry information of a vehicle are received by at least one remote server. The at least one remote server determines at least one content recommendation rule based on the at least one content recommendation and the telemetry information. The at least one remote server provides the at least one content recommendation rule to the head unit. The head unit detects an event associated with the head unit and selects content to present to the user based on a comparison of the detected event to the at least one content recommendation rule. The head unit then presents the selected content to the user.

### TECHNICAL FIELD

The present disclosure relates generally to displaying information to a user of a vehicle via a vehicle head unit.

### BACKGROUND

### Description of the Related Art

Automobiles are becoming more and more user friendly and interactive. Many new cars are now manufactured with a computer or digital user interface, called a head unit, which a user can use to control various aspects of the automobile and access a variety of content or applications. For example, the user can use the head unit to change radio stations, change the temperature of the automobile cabin, access maps and global positioning systems, access the internet, access other head-unit applications, or access or control other accessories of the automobile. The head unit can also provide various types of information or content to the user, such as when the automobile is due for an oil change or when a tire rotation should be performed, to name a few. Some newer head units can customize the information being provided, but the accuracy and usefulness may be impacted by lack of insight into the user's preferences.

### BRIEF SUMMARY

Briefly stated, embodiments are directed towards a system and method of generating content recommendation rules for a vehicle head unit. These recommendation rules are used by the head unit to determine if content should be presented to a user of the head unit and to select the appropriate content. In this way, a head unit can present recommended content to a user in near real time.

In general, one or more remote servers receive a content recommendation and telemetry information of a vehicle. The one or more remote servers determine at least one content recommendation rule based on the at least one content recommendation and the telemetry information. The one or more remote servers provide the at least one content recommendation rule to the head unit. The head unit detects an event associated with the head unit and selects content to present to the user based on a comparison of the detected event to the at least one content recommendation rule. The head unit then presents the selected content to the user.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a context diagram of a vehicle environment that communicates with a remote server to obtain content recommendations in accordance with embodiments described herein;

FIG. 2 illustrates a context diagram of a use case example for generating and pushing content recommendations to a vehicle head unit in accordance with embodiments described herein;

FIG. 3 illustrates a logical flow diagram generally showing one embodiment of a process for obtaining event information for a user and generating and pushing recommendations to a vehicle head unit based on the obtained event information in accordance with embodiments described herein;

FIG. 4 illustrates a logical flow diagram generally showing one embodiment of a process for generating rule sets for a head unit based on recommendations and vehicle information in accordance with embodiments described herein; and

FIG. 5 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

The term “vehicle” is defined as a device used to transport people or goods (or both), and examples include automobiles, buses, aircraft, boats, or trains. Although most of the following text focuses on an automobile, the application of the concepts described herein is not limited to such a vehicle, and embodiments can be utilized in other devices with networking capabilities for which bandwidth usage is a leading concern. A “processor” is defined as a component with at least some circuitry or other hardware that can execute instructions. A “head unit” is defined as one or more components, whether part of a single unit or a collection of units, at least some of which include circuitry, configured to perform computations related to image processing or present content arising from the image processing (or both). The term “user” is defined as a person or occupant that is in or otherwise transported by a vehicle or in control of the vehicle. The user may be the driver or a passenger of an automobile. The term “content” is defined as information related to an object that can be presented to a user of the vehicle. Content may include visual content, audio content, tactile content, or some combination thereof. Visual content can include text, graphics, symbols, video, or other information that is displayed to a user on a display device. Audio content can include songs, vocals, music, chimes, or other types of sounds that are provided to a user via a speaker. Tactile content can include vibrations, pulses, or other types of touch-based sensations provided to the user via a haptic interface.

Generalized types of content can include but are not limited to advertisements, sports scores or information, directions, restaurant menus, coupons, descriptive information, emergency instructions, etc.

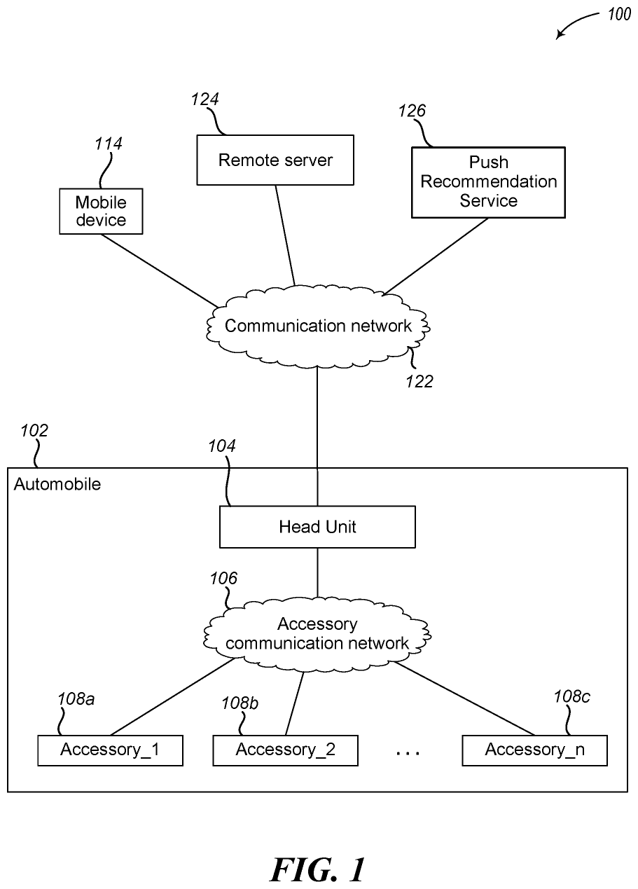

FIG. 1 illustrates a context diagram of a vehicle environment that communicates with a remote server to obtain content recommendations in accordance with embodiments described herein. System 100 includes a vehicle 102, a mobile device 114, a remote server 124, and a push recommendation service 126. The mobile device 114, the remote server 124, and the push recommendation service 126 work together to provide recommendations to a user of the vehicle 102.

Embodiments described herein utilize event information obtained by the user's mobile device 114 to provide recommendations to the user in the vehicle 102. Currently, some vehicles can track their own movement to detect habits of the driver. For example, assume the vehicle travels a specific route Monday through Friday starting at 9:00 AM and the vehicle stops at a particular coffee shop. The vehicle can predict that next Tuesday, the vehicle will again stop at the coffee shop. This prediction can be used to provide a targeted advertisement or other information to the user of the vehicle. Unfortunately, this information is generally contained to movement of the vehicle, and thus directed to the driver, and does not account for movement of a user when not in the vehicle or not the driver. For example, if the vehicle arrives at a parking lot of a mall, the vehicle may not be able to determine which store was of interest to the user. Similarly, if the user got a ride from a friend in another vehicle, the friend's vehicle would have no way of predicting the habits of the user.

Utilization of event information obtained by the user's mobile device 114 can provide more accurate recommendations to the user when the user is in the vehicle 102, independent of whether the user is the driver or the passenger. For example, assume a user frequently rides the bus or walks to various stores, and the user brings mobile device 114 with them. The mobile device 114 can obtain various different pieces of information related to points of interest or events associated with the user as the user visits the various stores. The mobile device 114 can provide event information to the push recommendation service 126, which obtains, selects, or generates a corresponding recommendation for the user. The push recommendation service 126 can provide the recommendation to remote server 124 to be provided to the vehicle 102. In this way, the user can receive more targeted content or recommendations based on the information obtained from the mobile device 114 compared to what the vehicle 102 can deduce by itself.

The vehicle 102 has a head unit 104 and one or more accessories 108a-108c. The vehicle 102 is virtually any means of transportation that includes a computing device and an output interface to provide content to a user of the vehicle 102. In the illustrative examples described herein, the computing device of the vehicle is the head unit 104, although other types of computing devices may be employed. Moreover, examples of vehicles include automobiles, aerial vehicles, water vessels, railroad vehicles, and other modes of transportation.

The accessories 108a-108c can be any device or process that provides information or data directly or indirectly (such as via the head unit 104) to the user. Examples include the following: gas-level gauge, speedometer, odometer, oil-pressure gauge, temperature gauge, tire-pressure gauge, GPS device, ignition-status indicator, gear-shift mechanics or electronics indicating a gear state or change of state, seat-belt-status indicator, seat-weight sensors, clock, or other vehicle sensor that provides information to a user.

In some embodiments, one or more of the accessories 108a-108c may provide collected information to the head unit 104 via an accessory communication network 106. In other embodiments, the head unit 104 may control one or more of the accessories 108a-108c by providing information or instructions to the accessories via the accessory communication network 106. The accessory communication network 106 may include one or more physical networks; one or more wireless communication networks; one or more application program interfaces; or one or more other networks capable of transmitting data from one accessory to another, from an accessory to the head unit 104, or from the head unit to an accessory; or some combination thereof depending on the types of accessories communicating with the head unit 104. For example, the accessory communication network 106 may include an automotive body communication network, such as a wired controller area network, short-range wireless communication network, such as personal-area networks utilizing Bluetooth Low Energy protocols, or any other type of network.

The head unit 104 is a computing device that provides content, interactive controls, user interfaces, or other information to users of the vehicle 102. As an illustrative example, the head unit 104 may provide a navigation interface, audio and radio controls, environmental controls, automobile performance or maintenance information, or other types of content. In various embodiments, the head unit 104 may present content to a user based on recommendations received from the remote server 124. In some embodiments, the head unit 104 may simply present the recommendation to the user. For example, the recommendation may be an advertisement for a clothing store that the user recently visited. In this example, the remote server 124 may provide the advertisement recommendation to the head unit 104 for the head unit 104 to display. In other embodiments, the head unit 104 may select or generate the content based on the recommendation. For example, the recommendation may indicate that the user visited a dry cleaner on Monday. In this example, the head unit 104 can generate a reminder content based on the recommendation the next time the vehicle is in proximity to the dry cleaner. In various embodiments, the head unit 104 may obtain or identify a new vehicle telemetry event, such as the vehicle 102 starting, arriving at a geographical position or area, etc. The new vehicle telemetry event is compared to one or more recommendation rules, which are used to generate real time recommendations when a match is identified between the new vehicle telemetry event and the recommendation rules. For example, the telemetry event could be the vehicle started while at the driver's place of work on a day that the driver visited a dry cleaner and the recommendation may be for the driver go back to the dry cleaner. As another example, the telemetry event could be the vehicle starting while at the driver's home on a day that the driver commonly goes to a restaurant after work (e.g., Friday) and the recommendation may be for select restaurants and offer to make a reservation.

The remote server 124 is any combination of computing devices, such as one or more servers or other cloud resources, which is remote to the vehicle 102 and can provide recommendations, content, or other information to the head unit 104 via communication network 122. The remote server 124 receives recommendations from the push recommendation service 126 via the communication network 122. In some embodiments, the remote server 124 forwards the recommendations to the head unit 104. In other embodiments, the remote server 124 selects or generates content to be provided to the head unit 104 based on the recommendations.

In some embodiments, the remote server 124 may receive telemetry data or other information from the head unit 104 for further processing and analytics. The remote server 124 can select or determine additional recommendations for the head unit 104 based on the information received from the head unit 104.

Although the remote server 124 is illustrated as a single device, embodiments are not so limited. Rather, the remote server 124 may be one or more computer devices that perform one or more functions. The push recommendation service 126 is any combination of computing devices, such as one or more servers or other cloud resources, which is remote to the vehicle 102 and the mobile device 114 and can generate or obtain recommendations based on information received from the mobile device 114. In various embodiments, the push recommendation service 126 receives event information from mobile device 114 via communication network 122. The push recommendation service 126 uses this event information to select or generate one or more recommendations to provide to the head unit 104. The push recommendation service 126 provides the recommendations to the remote server 124 via communication network 122 to be provided to the head unit 104.

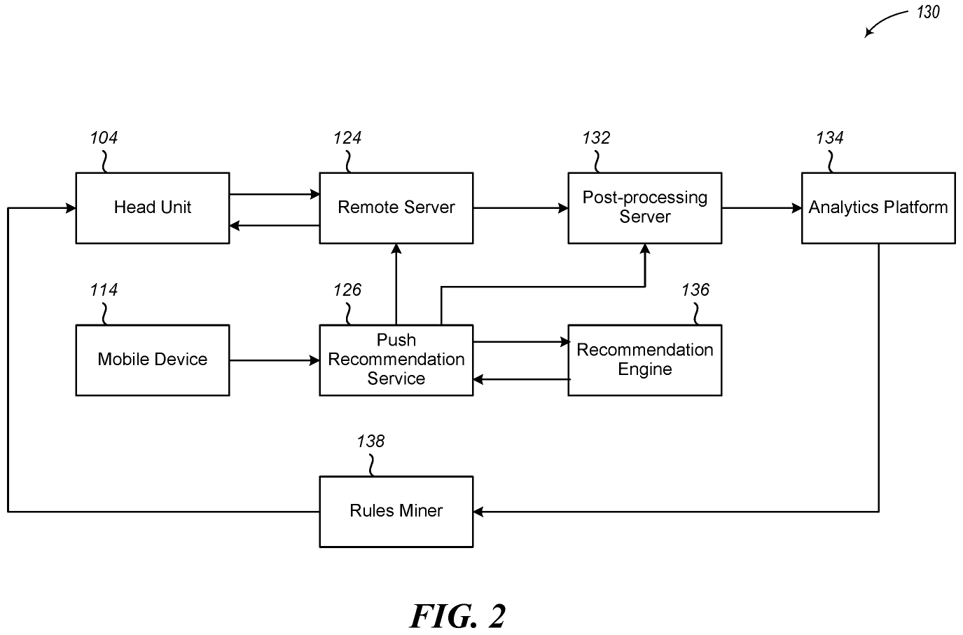

Although the remote server 124 is illustrated as a single device, embodiments are not so limited. Rather, the remote server 124 may be one or more computer devices that perform one or more functions. In various embodiments, the remote server 124 may include one computing device or a plurality of computing devices, but may be generally referred to herein as a remote server. For example, a first computing device (not illustrated) of the remote server 124 may operate as analytics platform (e.g., analytics platform 134 in FIG. 2) and a second computing device (not illustrated) of the remote server 124 may operate as a rules miner (e.g., rules miner 138 in FIG. 2). As another example, a single computing device may operate as the remote server 124 to provide the functionality of the analytics platform and the rules miner.

The mobile device 114 includes any computing device capable of obtaining event information and providing the event information to the push recommendation service 126. The event information may include position information (e.g., GPS data), time information (e.g., timestamp, duration, etc.), activity information (e.g., walking, biking, shopping, eating, etc.), or other types of information that may indicate what the user was doing when not in the vehicle 102.

The mobile device 114 may have installed thereon one or more computing applications. In some embodiments, one or more of these computing applications may be referred to as companion applications of the head unit 104 or companion applications of applications installed on the head unit 104. For example, the head unit 104 and the mobile device 114 may have applications installed thereon for a particular dry cleaner. When a user enters the premises of the dry cleaner with the mobile device 114, then the companion application may determine that the dry cleaner is considered to be a point of interest or event. In response, the companion application on the mobile device 114 collects event information of the mobile device 114 associated with the point of interest or event. The mobile device 114 provides this event information to the push recommendation service 126 via communication network 122 to determine a recommendation to provide to the head unit 104.

Examples of the mobile device 114 include laptop computers, smart phones, tablet computers, wearable computing devices, other smart devices, or other handheld computing devices. FIG. 2 illustrates a context diagram of a use case example of a system 130 for generating and pushing content recommendations to a vehicle head unit in accordance with embodiments described herein. System 130 includes a head unit 104, a remote server 124, a push recommendation service 126, a recommendation engine 136, and a mobile device 114.

The mobile device 114 employs various analytics and user-tracking mechanisms to detect points of interest or events associated with the user. These tracking mechanisms may include, but are not limited to, determining habits of the user (e.g., following a same route through a mall), identifying stores the user likes to visit, the length of stay or timing of trips, etc. The mobile device 114 collects event information associated with each detected event or point of interest. The event information may include positional or location information or other information related to the point of interest or event, such as time or day, frequency of visits, length of visit, etc.

In various embodiments, a third party application executing on the mobile device 114 may identify or detect points of interest or events associated with the user. In at least one such embodiment, the third party application may be in communication with a companion application and provide at least some of the information associated with the points of interest or events to the companion application. In some embodiments, the companion application may be an application for a same service or product of an application executing on the head unit 104. In other embodiments, the companion application may be an application associated with the head unit 104. For example, the companion application may obtain access to or provide commands to the head unit 104 when the mobile device 114 is within a predetermined threshold distance from the head unit 104 (e.g., within Bluetooth communication range). In this way, the user can utilize the companion application to instruct the head unit 104 to perform a command (e.g., turning the radio volume up or down) or to receive vehicle information (e.g., current oil pressure).

The mobile device 114, whether via a companion application or some other application, provides the event information of a detected point of interest or event to the push recommendation service 126. The event information may include GPS coordinates, a name of a particular store or location, a timestamp, a duration of attending the point of event or event, etc. The event information may also include information provided by the user, such as, but not limited to, an order number, confirmation number, phone number, product or service description, or other information associated with the point of interest or event. For example, the user can input a dry cleaner pick-up date and confirmation number.

The push recommendation service 126 is in communication with a recommendation engine 136 to obtain a recommendation based on the event information obtained from the mobile device 114. In various embodiments, the recommendation engine 136 includes a database or analytics mechanism to select or generate the recommendation based on the event information. For example, if the event information is associated with a clothing store, then the recommendation may be a coupon to the store. But if the event information is associated with a dry cleaner, then the recommendation may be a reminder to pick up the dry cleaning. In some embodiments, the recommendation may be content to present to the user. In other embodiments, the recommendation may be instructions for another computing device (e.g., the remote service 124 or the head unit 104) to generate the content to present to the user.

The push recommendation service 126 provides the recommendation to the remote server 124. The remote server 124 provides the recommendation to the head unit 104. In some embodiments, the remote server 124 simply forwards the recommendation to the head unit 104 for display. In other embodiments, the remote server 124 may selected content to provide to the head unit 104 based on the recommendation.

In some embodiments, the remote server 124 may provide the recommendation to the head unit 104 in near real time via a cellular network connection. In other embodiments, the remote server 124 may provide the recommendation to the head unit 104 via a short rage wireless connection, such as via a Wi-Fi connection when the vehicle is parked at the user's house or connected to a public Wi-Fi access point.

The head unit 104 can then present the recommendation to the user. The recommendation may be any type of audio or visual content that can be presented to the user. In some embodiments, the recommendation may be displayed on a graphical user interface of the head unit 104. In other embodiments, the recommendation may be an audio alert via an audio interface within the vehicle. In yet other embodiments, the head unit 104 may forward the recommendation to the user's mobile device, which may be the same device as mobile device 114 or some other mobile device.

In various embodiments, the system 130 may also include a post-processing server 132, an analytics platform 134, and a rules miner 138. In some embodiments, the head unit 104 can also provide information to the remote server 124, which may include telemetry data of the vehicle, user inputs to the head unit 104, information from various accessories on the vehicle (e.g., gas level, oil pressure, radio stations of interest to the user, etc.).

The remote server 124 can provide this additional information to the post-processing server 132. In some embodiments, the post-processing server 132 may also receive, from the push recommendation service 126 or the remote server 124 (or even from the recommendation engine 136), the recommendation that was provided to the head unit 104. The post-processing server 132 can perform one or more analysis or processing mechanisms on the recommendation and the information received from the head unit 104 to generate additional insight into the movement and behavior of the user. For example, the recommendation may be a coupon for a particular gas station. If the information from the head unit 104 indicates that the vehicle associated with the head unit 104 traveled to the gas station, then the post-processing server 132 can label the recommendation as a successful recommendation.

The post-processing server 132 can provide the recommendation and any information received from the head unit 104 to the analytics platform 134. The analytics platform 134 manages previous recommendations, telemetry information, and other information from one or more head units, one or more vehicles, one or more drivers, or a combination thereof. In various embodiments, the telemetry information includes sensor data, e.g., GPS data, collected from one or more sensors on the vehicle. Other information obtained from the vehicle may include user interaction data or user impression data. The user interaction data may include information indicating what head unit applications or features are being used and interacted with. The user impression data may include information indicating what recommendations are being displayed and when.

The rules miner 138 can discover or obtain rules based on the recommendations and other information maintained by the analytics platform 134.

These rules can then be provided to the head unit 104. The head unit 104 can utilize these rules to generate recommendations for the driver or user of the head unit 104.

The rules miner 138 can analyze the information stored by the analytics platform 134 to generate rules or aggregated rules. In some embodiments, the telemetry information is transformed or featurized into something that has more semantic meaning. Examples of such semantic features may include the driver is leaving home (e.g., based on GPS data), the driver ordered a coffee (e.g., based on head unit application interaction), and the driver found a previous recommendation relevant (e.g., an impression associated with the recommendation lead to the driver going to the coffee shop). With these semantic features, the rules miner 138 can apply machine learning techniques to identify user behavioral rules for one or more drivers or users.

As one example, the rules miner 138 may determine, generate, or identify a rule that those drivers who buy coffee in the morning also purchase a pastry. This rule can be sent to the head unit 104, e.g., from the rules miner 138, for the head unit 104 to recommend pastries when the driver orders a coffee in the morning, e.g., by determining that the vehicle has arrived at a coffee shop or if the driver uses the head unit 104 to order the coffee.

As another example, the rules miner 138 may discover that drivers only buy coffee in the morning on work days when they are not going to be late. The rules miner 138 can utilize various information to define the driver's typical work day. For example, driving patterns, electronic-calendar entries, or driver-set work times may be used to determine which days are typically work days for the driver and what time the driver arrives at work or begins the work day. This additional rule is then provided to the head unit 104. The head unit 104 can determine if the driver is going to be late due to a departure time later than their average departure time or current traffic conditions along the driver's typical route to work. The head unit 104 can then utilize the additional rule filter out recommendations not directly related to the driver's work when determining that the driver is running late.

In some embodiments, the rules miner 138 can aggregate information associated with multiple users, multiple mobile devices, or multiple head units, to generate global recommendations for a plurality of users. For example, the rules miner 138 can determine that 30% of users who received a particular coffee shop coupon visited the coffee shop or users who received reminders to pick up their dry cleaning were 45% more likely to stop at the dry cleaners within one business day. The rules miner 138 can aggregate information across different user demographics, different makes or models of vehicles, locations, etc.

The rules miner 138 can determine and provide the rules or aggregated recommendations to the head unit 104. In some embodiments, the rules miner 138 can apply one or more rules set by the user or an administrator to provide additional rules or recommendations to the head unit 104. For example, the user can set a rule indicating that the user likes to visit sporting goods stores. If the rules miner 138 discovers a rule or aggregated recommendation associated with the particular sporting goods store, then the rules miner 138 can provide the rule or recommendation to the head unit 104. In some embodiments, the rules miner 138 may provide the rules or additional recommendations to the head unit 104 via a cellular connection or a short-range wireless communication (e.g., Wi-Fi), similar to remote server 124. In other embodiments, the rules miner 138 may provide the additional recommendation to the remote server 124 for forwarding to the head unit 104.

Although FIG. 2 illustrates the remote server 124, the push recommendation service 126, the recommendation engine 136, the post-processing server 132, the analytics platform 134, and the rules miner 138 as separate components of system 130, embodiments are not so limited. One computing device or a plurality of computing devices can perform the functionality of the remote server 124, the push recommendation service 126, the recommendation engine 136, the post-processing server 132, the analytics platform 134, and the rules miner 138.

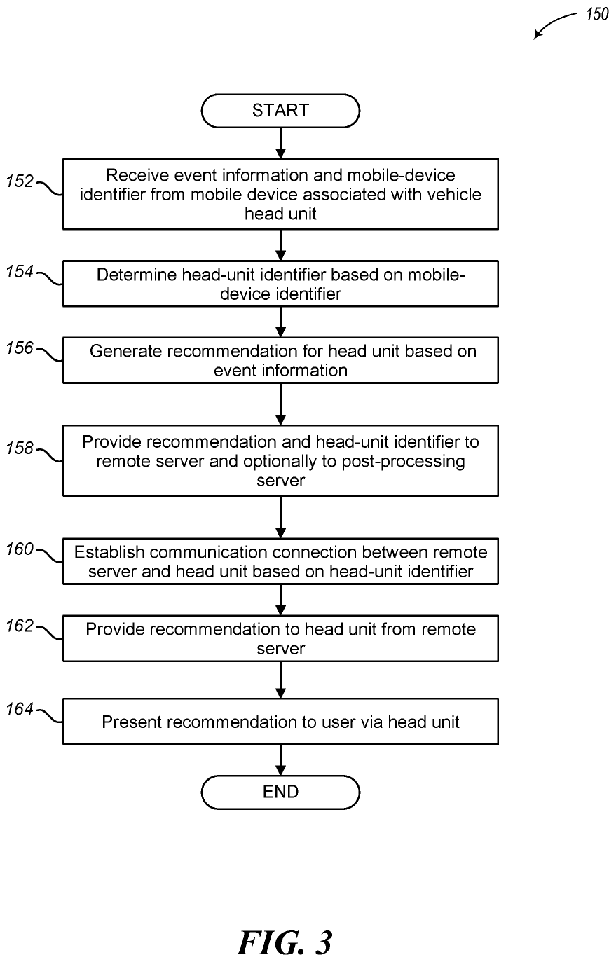

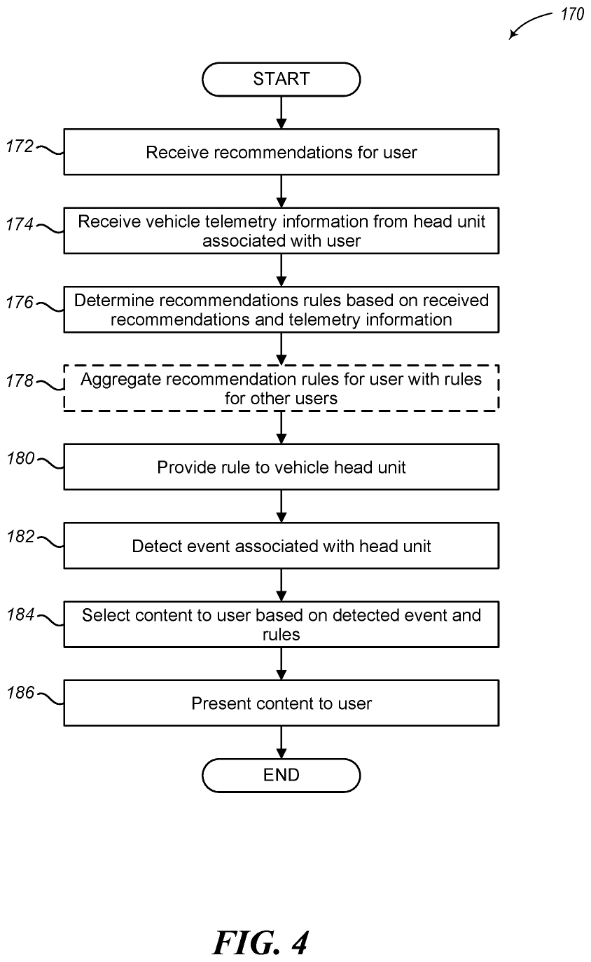

The operation of certain aspects of the disclosure will now be described with respect to FIGS. 3 and 4. In at least one of various embodiments, processes 150 and 170 described in conjunction with FIGS. 3 and 4, respectively, may be implemented by or executed by a system of one or more computing devices, such as some combination of mobile device 114, head unit 104, remote server 124, push recommendation service 126, recommendation engine 136, post-processing server 132, analytics platform 134, and rules miner 138 in FIG. 2.

FIG. 3 illustrates a logical flow diagram generally showing one embodiment of a process 150 for obtaining event information associated with points of interest and generating and pushing recommendations to a vehicle head unit based on the obtained event information in accordance with embodiments described herein.

Process 150 begins, after a start block, at block 152, where event information of points of interest or events and a mobile-device identifier are is received from a mobile device.

The mobile device is associated with a vehicle head unit. This association may be set up by the mobile device user in which the user subscribes or registers the mobile-device as being associated with one or more vehicle head units. In various embodiments, a database may store the association or relationship between mobile-device identifiers and head-unit identifiers. The mobile-device identifier and the head-unit identifier may be telephone numbers, unique equipment serial numbers, user-defined identifiers (e.g., an email address or user name), etc.

The event information may include any information indicative of a point of interest or event for the user. The event information may include GPS data, store names, general area information (e.g., city or neighborhood), time of day, duration, frequency, etc.

As discussed above, the point of interest or event may be determined by the mobile device as the user travels or visits different locations. The points of interest or events may be inferred from the user's behavior or habits, which are detected by monitoring where the mobile device is and how the user is using the mobile device. In some embodiments, the points of interest or events may also be obtained from input from the user, such as calendar entries, internet searches, etc.

In various embodiments, the event information may be determined when the user is not travelling in the vehicle. In other embodiments, the event information may be determined independent of whether or not the user is in the vehicle.

Process 150 proceeds to block 154, where a head-unit identifier is determined based on the received mobile-device identifier. As mentioned above, a database may store the association or relationship between mobile-device identifiers and head-unit identifiers. In various embodiments, this database may be queried using the mobile-device identifier to obtain the corresponding head-unit identifier.

Process 150 continues at block 156, where a recommendation is generated for the head unit based on the event information. In various embodiments, the event information and head-unit identifier are provided to a recommendation engine. The recommendation engine can then generate the recommendation for the head unit. In some embodiments, a database may store a plurality of recommendations and a plurality of related event information. In at least one embodiment, the database may be customized for the head unit or the user based on previous recommendations or information from the user, such as aggregated recommendations generated by rules miner 138 in FIG. 2.

In some embodiments, the recommendation is audio or visual content to present to the user of the head unit. In other embodiments, the recommendation includes information or instructions indicating how content is to be generated or presented to the user.

Process 150 proceeds next to block 158, where the recommendation and head-unit identifier are provided to a remote server. In some embodiments, the recommendation is also optionally provided to a post-processing server.

Process 150 continues next at block 160, where a communication connection is established between the remote server and the head unit based on the head-unit identifier. In some embodiments, this connection is a cellular connection. In other embodiments, this connection is a short-range wireless connection, such as Wi-Fi. In some embodiments, the head unit and the remote server may have established a keep-alive connection, where the head unit subscribes to topics in which to receive recommendations from the remote server. Similarly, the remote server can subscribe to topics in which to receive information and data from the head unit. Process 150 proceeds to block 162, where the remote server provides the recommendation to the head unit via the established communication connection.

Process 150 continues at block 164, where the head unit presents the recommendation to the user. In some embodiments, the head unit generates a user experience based on the recommendation. The user experience may include audio or visual content that can be rendered by the head unit and presented to the user. As indicated above, the recommendation may include content to present to the user or it may include instructions indicating what content to present to the user. The head unit can output video or audio associated with the recommendation to the user via one or more video interfaces or one or more audio interfaces, or some combination thereof.

In various embodiments, post-processing of the recommendation may be performed to provide additional recommendations to the head unit, such as discussed in conjunction with FIG. 4.

In some embodiments, the head unit may provide telematics or other information to the remote server, which can then be provided to the post-processing server. This information can be analyzed and compared to the recommendation to determine if the user accepted the recommendation or altered their behavior based on the recommendation. In some embodiments, one or more machine learning or artificial intelligence mechanisms or models may be utilized to determine the effectiveness of the recommendation.

In various embodiments, recommendations and user information may be aggregated from a plurality of recommendations. In at least one embodiment, the user or the head unit may set one or more rules defining what recommendations can be provided to the head unit based on the aggregated recommendations.

After block 166, process 150 terminates or otherwise returns to a calling process to perform other actions. In some embodiments, process 150 may loop (not illustrated) to block 152 to receive additional event information for additional points of interest or events from the mobile device, which can be used to generate and provide additional recommendations to the head unit.

FIG. 4 illustrates a logical flow diagram generally showing one embodiment of a process 170 for generating rule sets for a head unit based on recommendations and vehicle information in accordance with embodiments described herein.

Process 170 begins, after a start block, at block 172, where recommendations for a user are received. In various embodiments, the post-processing server 132 receives the recommendations from the push recommendation server 126. In at least one embodiment, the post-processing server 132 provides the recommendations to the analytics platform 134, as discussed above.

Process 170 proceeds to block 174, where vehicle telemetry information is received from a head unit associated with the user. In various embodiments, the post-processing server 132 receives the vehicle telemetry information from the remote server 124 after the remote server 124 receives or collects the information from the head unit 104. In at least one embodiment, the post-processing server 132 provides the vehicle telemetry information to the analytics platform 134.

As discussed above, the vehicle telemetry information may include GPS position information, speed information, trip or route information, frequency of use, user input information, head unit use information, or other information collected by the head unit 104. In some embodiments, the information from the head unit may be generally referred to as vehicle information or head unit information.

Process 170 continues at block 176, where one or more recommendation rules are generated for the user based on the recommendations and the vehicle telemetry information. Each of the rules may include a condition and result. The condition may include categories or instructions that correlate to the tags of events such that, when met, the result of the rule is executed. For example, one rule may be “when the vehicle is within 1 km of ‘Store A,’ then display ‘coupon_y’ to user via head unit.”

In various embodiments, one or more machine learning or artificial intelligence mechanisms may be employed to detect patterns or specific conditions in the movement of the vehicle based on the telemetry information. These patterns or conditions can be compared to the recommendations to determine if the user responded positively to the recommendation and proceeded to follow the recommendation or if the user ignored the recommendation. For example, if the recommendation was a reminder to pick up the dry cleaning and the vehicle (based on the telemetry data) proceeded straight to the dry cleaners, then the a rule can be generated indicating that when the vehicle is within a threshold distance (e.g., 1 km) of the dry cleaners, remind the user to pick up the dry cleaning. As another example, a rule can be set such that the recommendation to pick up the dry cleaning is provided to the driver on vehicle start when the vehicle is at work and the vehicle stopped at the dry cleaner earlier that the day or on the previous day.

Process 170 proceeds next to block 178, where the recommendation rules for the user are aggregated with recommendation rules of other users. In some embodiments, block 178 is optional and is not performed. In various embodiments, rules of multiple users can be anonym ized then aggregated to provide additional recommendations to the user. For example, if the user, and a plurality of users, respond positively to recommendations for “store_A” and the plurality of users have also responded positively to recommendations for “store_B,” then the rule for recommending store_B can be added to the recommendations for the user.

Process 170 proceeds to block 180, where the recommendation rules generated at block 176 or optionally aggregated at block 178 are provided to the vehicle head unit. In some embodiments, the generated rules are provided to the head unit 104 via a short-range wireless communication connection, such as Wi-Fi. As one example scenario, the rules miner 138 provides the rules to the head unit 104 when the vehicle that includes the head unit is at the user's home. In this way, multiple rules can be provided to the head unit without requiring cellular bandwidth. In some other embodiments, the rules miner 138 may provide the rules to the head unit via a cellular connection or other communication protocol or connection.

Process 170 continues at block 182, where the head unit 104 detects an event associated with the head unit 104. In various embodiments, the head unit 104 monitors and tracks the movement of the vehicle to detect events or points of interest. For example, the head unit may detect a point of interest or event when the vehicle comes within a threshold distance from a particular store location. As another example, the head unit may detect an event when the vehicle travels along a route.

Process 170 proceeds next to block 184, where the head unit selects content to present to the user based on the detected event and one or more previously stored rules. In various embodiments, the event may be tagged with one or more characteristics or categories associated with the event. Example tags may include walking, visiting a store, going grocery shopping, etc. These tags may also be specific to a given location, such as “Store_A,” “Park_B,” or traveling to “Work_C.” The tags are compared to the conditions of the rules to determine if the event matches any of the rules. If there is a match, then content is selected based on the result portion of the rule. The content can be visual content, audio content, tactile content, etc., which can include advertisements, sports scores or information, directions, restaurant menus, coupons, descriptive information, emergency instructions, etc.

Process 170 continues next at block 186, where the head unit presents the selected content to the user. In various embodiments, block 186 may employ embodiments of block 164 in FIG. 3 to present content to the user.

After block 186, process 170 terminates or otherwise returns to a calling process to perform other actions.

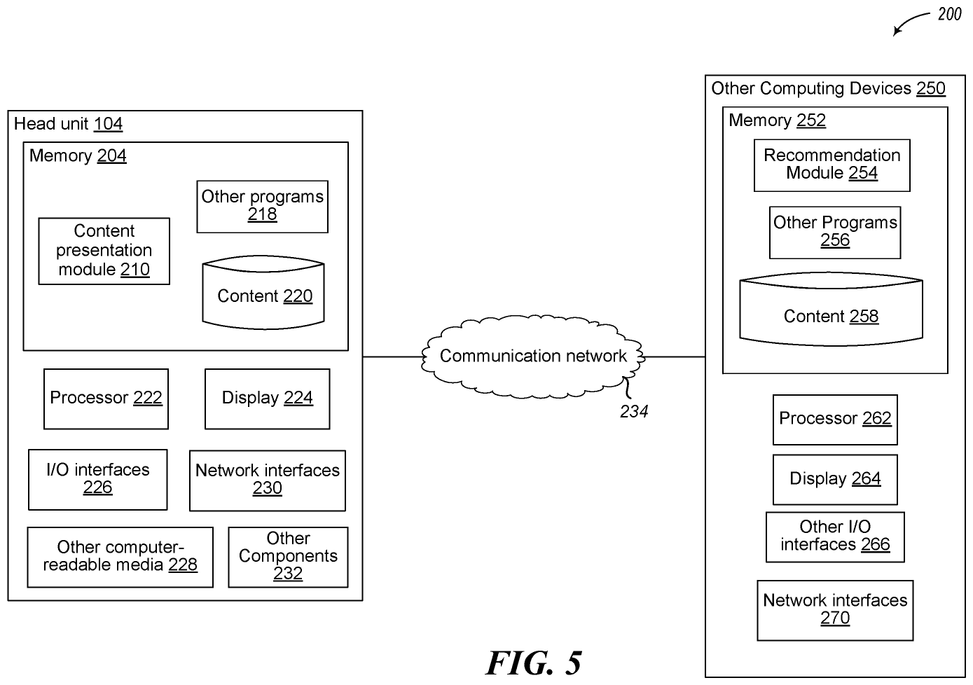

FIG. 5 shows a system diagram that describes one implementation of computing systems for implementing embodiments described herein. System 200 includes head unit 104 and one or more other computing devices 250.

As described herein, head unit 104 is a computing device that can perform functionality described herein for receiving recommendations and presenting content to a user. One or more special purpose computing systems may be used to implement the head unit 104. Accordingly, various embodiments described herein may be implemented in software, hardware, firmware, or in some combination thereof. The head unit 104 includes memory 204, one or more processors 222, display 224, other input/output (I/O) interfaces 226, other computer-readable media 228, network interface 230, and other components 232.

Processor 222 includes one or more processing devices that execute computer instructions to perform actions, including at least some embodiments described herein. In various embodiments, the processor 222 may include one or more central processing units (“CPU”), programmable logic, or other processing circuitry.

Memory 204 may include one or more various types of non-volatile and/or volatile storage technologies. Examples of memory 204 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 204 may be utilized to store information, including computer-readable instructions that are utilized by processor 222 to perform actions, including at least some embodiments described herein.

Memory 204 may have stored thereon various modules, such as content presentation module 210. The content presentation module 210 provides functionality to receive recommendations from the other computing device 250, which may include remote server 124 in FIG. 1. The content presentation module 210 provides the recommendation or content to the user, such as via display 224, or other I/O interfaces 226.

Memory 204 may also store other programs 218 and other content 220. Other programs 218 may include operating systems, user applications, or other computer programs. Content 220 may include visual, audio, or tactile content to provide to the user, as described herein. Display 224 is a display device capable of rendering content to a user. In various embodiments, the content selected by the content presentation module 210 is presented to the user via the display 224. The display 224 may be a liquid-crystal display, light-emitting diode, or other type of display device, and may include a touch-sensitive screen capable of receiving inputs from a user's hand, stylus, or other object.

I/O interfaces 226 may include interfaces for various other input or output devices, such as audio interfaces, other video interfaces, USB interfaces, physical buttons, keyboards, haptic interfaces, tactile interfaces, or the like.

Other computer-readable media 228 may include other types of stationary or removable computer-readable media, such as removable flash drives, external hard drives, or the like.

Network interfaces 230 are configured to communicate with other computing devices, such as the other computing devices 250, via a communication network 234. Network interfaces 230 include transmitters and receivers (not illustrated) to send and receive data as described herein. The communication network 234 may include the communication network 122 of FIG. 1.

The other computing devices 250 are computing device that are remote from the head unit 104, and in some embodiments, can perform functionality described herein for generating recommendations to provide to the head unit 104 for a user. The other computing devices 250 may include mobile device 114, remote server 124, push recommendation service 126, recommendation engine 136, post-processing server 132, analytics platform 134, or the rules miner 138 in FIG. 2.

One or more special-purpose computing systems may be used to implement the other computing devices 250. Accordingly, various embodiments described herein may be implemented in software, hardware, firmware, or in some combination thereof.

The other computing devices 250 includes memory 252, one or more processors 262, display 264, I/O interfaces 266, and network interface 270, which may be similar to or incorporate embodiments of memory 204, processor 222, display 264, I/O interfaces 226 and network interface 270 of head unit 104, respectively. Thus, processor 262 includes one or more processing devices that execute computer instructions to perform actions, including at least some embodiments described herein. In various embodiments, the processor 222 may include one or more CPUs, programmable logic, or other processing circuitry.

Memory 252 may include one or more various types of non-volatile and/or volatile storage technologies. Memory 252 may be utilized to store information, including computer-readable instructions that are utilized by processor 262 to perform actions, including at least some embodiments described herein. Memory 252 may also store recommendation module 254, other programs 256, and content 258. The recommendation module 254 may perform embodiments described herein to generate recommendations based on event information provided by a mobile device and provide the recommendations to the head unit 104. The other programs 256 may include operating systems or other applications.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A system, comprising:
at least one remote server that includes a first memory to store first computing instructions and a first processor to execute the first computing instructions to:
receive at least one content recommendation for a user of a head unit of a vehicle;
receive telemetry information of the vehicle;
determine at least one content recommendation rule based on the at least one content recommendation and the telemetry information; and
provide the at least one content recommendation rule to the vehicle; and
a head unit of the vehicle that includes a second memory to store second computing instructions and a second processor to execute the second computing instructions to:
collect and provide the telemetry information to the at least one remote server;
detect an event associated with the head unit;
select content to present to the user based on a comparison of the detected event to the at least one content recommendation rule; and
present the selected content to the user.

2. The system of claim 1, wherein the first processor of the at least one remote server further executes the first computing instructions to:
aggregate the at least one content recommendation rule for the user with at least one other content recommendation rule for at least one other user of at least one other head unit.

3. The system of claim 2, wherein the first processor of the at least one remote server further executes the first computing instructions to:
provide the aggregated content recommendation rules to the head unit.

4. The system of claim 1, further comprising:
wherein the first processor of the at least one remote server further executes the first computing instructions to:
aggregate the at least one content recommendation rule with a plurality of other content recommendation rules for other users; and
provide the aggregated content recommendation rules to the head unit; and
wherein the second processor of the head unit further executes the second computing instructions to:
select the content to present to the user based on a comparison of the detected event to the aggregated content recommendation rule.

5. The system of claim 1, wherein the second processor of the head unit selects the content to present to the user by further executing the second computing instructions to:
compare the detected event to conditions of the at least one content recommendation rule; and
in response to a match between the detected event and a condition of a particular content recommendation rule, select a result of the particular content recommendation rule that corresponds to the condition.

6. The system of claim 1, wherein the first processor of the at least one remote server determining the at least one content recommendation rule by further executing the first computing instructions to:
identify a movement pattern of the vehicle based on the telemetry information;
identify a destination associated with the at least one content recommendation;
in response to the destination being along the movement pattern of the vehicle, determine that the user responded positively to the at least one content recommendation; and
generate a content recommendation rule based on the positive response of the user and the at least one content recommendation.

7. A computer-implemented method, comprising:
receiving at least one content recommendation for a user of an head unit of a vehicle;
receiving telemetry information of the vehicle;
determining at least one content recommendation rule based on the at least one content recommendation and the telemetry information;
providing the at least one content recommendation rule to the head unit;
detecting an event associated with the head unit;
selecting content to present to the user based on a comparison of the detected event to the at least one content recommendation rule; and
presenting the selected content to the user.

8. The computer-implemented method of claim 7, further comprising:
aggregating the at least one content recommendation rule for the user with at least one other content recommendation rule for at least one other user of at least one other head unit.

9. The computer-implemented method of claim 8, further comprising:
providing the aggregated content recommendation rules to the head unit.

10. The computer-implemented method of claim 7, further comprising:
aggregating the at least one content recommendation rule with a plurality of other content recommendation rules for other users;
providing the aggregated content recommendation rules to the head unit; and
selecting the content to present to the user based on a comparison of the detected event to the aggregated content recommendation rule.

11. The computer-implemented method of claim 7, wherein selecting the content to present to the user further comprises:
comparing the detected event to conditions of the at least one content recommendation rule; and
in response to a match between the detected event and a condition of a particular content recommendation rule, selecting a result of the particular content recommendation rule that corresponds to the condition.

12. The computer-implemented method of claim 7, wherein determining the at least one content recommendation rule further comprises:
identifying a movement pattern of the vehicle based on the telemetry information;
identifying a destination associated with the at least one content recommendation;
in response to the destination being along the movement pattern of the vehicle, determining that the user responded positively to the at least one content recommendation; and
generating a content recommendation rule based on the positive response of the user and the at least one content recommendation.

13. A computing device, comprising:
at least one memory that stores computer instructions; and
at least one processor that performs actions when executing the computer instructions, the actions including:
receiving at least one content recommendation for a user of a head unit of a vehicle;
receiving, from the head unit, telemetry information of the vehicle;
determining at least one content recommendation rule based on the at least one content recommendation and the telemetry information; and
providing the at least one content recommendation rule to the head unit for the head unit to detect an event associated with the head unit and select content to present to the user based on a comparison of the detected event to the at least one content recommendation rule.

14. The computing device of claim 13, wherein the at least one processor executes the computer instructions to perform further actions, the further actions include:
aggregating the at least one content recommendation rule for the user with at least one other content recommendation rule for at least one other user of at least one other head unit.

15. The computing device of claim 14, wherein the at least one processor executes the computer instructions to perform further actions, the further actions include:
providing the aggregated content recommendation rules to the head unit.

16. The computing device of claim 13, wherein the at least one processor executes the computer instructions to perform further actions, the further actions include:
aggregating the at least one content recommendation rule with a plurality of other content recommendation rules for other users; and
providing the aggregated content recommendation rules to the head unit for the head unit to select the content to present to the user based on a comparison of the detected event to the aggregated content recommendation rule.

17. The computing device of claim 13, wherein the at least one processor executes the computer instructions to perform further actions, the further actions include:
identifying a movement pattern of the vehicle based on the telemetry information;
identifying a destination associated with the at least one content recommendation;
in response to the destination being along the movement pattern of the vehicle, determining that the user responded positively to the at least one content recommendation; and
generating a content recommendation rule based on the positive response of the user and the at least one content recommendation.
